(19) United States
(12) Patent Application Publication
(10) Pub. No.: US 2004/0168116 A1
(43) Pub. Date: Aug. 26, 2004

(54) Print control apparatus

(75) Inventor: Yukiko Shikata, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/727,993

(22) Filed: Dec. 5, 2003

(30) Foreign Application Priority Data
Dec. 9, 2002 (JP) 2002-357114

(51) Int. Cl. G06F 15/00

(52) U.S. Cl. 715/500; 358/1.1

(57) ABSTRACT

The present invention provides a print control apparatus which comprises an information obtaining means which obtains from a printer, information regarding a consumed level of a consumable item, a receiving means which selectively receives a setting from a user in which a notice that the consumed level of the consumable item is in advanced stage is limited to once within a predetermined period of time, a notifying means which notifies the user that the consumed level of the consumable item is in advanced stage, and a determining means which determines whether or not the user is notified of the advanced consumed level as to the consumable item whose consumed level is found to be in advanced stage according to the information regarding the consumed level, wherein, when the consumable item whose consumed level is found to be in advanced stage has a setting that the notice as to advanced consumed level is limited to once within the predetermined period of time, and the notice has already been given within the predetermined period of time, the determining means determines that the user is not notified of the advanced consumed level, and when the notice has not been given within the predetermined period of time, the determining means determines that the user is notified of the advanced consumed level. Accordingly, it is possible to enhance the convenience of a user, regarding the notice that the consumed level of a consumable item in a printer is in advanced stage.

### FIELD OF THE INVENTION

The present invention relates to a print system, and more particularly it relates to a technique to notify a user that a consumed level of a consumable item in a printer is in advanced stage.

### BACKGROUND OF THE INVENTION

A laser printer forms on a photoconductor drum a print image based on print data transmitted from a host computer, by means of a laser beam. Then, printing is carried out, by allowing toner to adhere on the print image that is electrically charged by the laser beam, and transferring the toner to a print sheet. A printer of such laser type as described above is provided with a toner cartridge filled with toner, a photoconductor drum, a waste toner box for storing excessive toner, those items being so called consumable items, and they are consumed, deteriorated and the like, as printing proceeds. Therefore, the consumable items need replacing when the consumed level thereof is in advanced stage.

Accordingly, a printer host obtains status information regarding a consumed level as to each consumable item from the printer, and when the information indicates that the consumed level is in advanced stage, the printer host notifies a user of the information by displaying such status on a screen.

It is possible to carry out printing, even if the consumed level of the consumable item, such as a toner cartridge., a photoconductor drum, and a waste toner box for storing excessive toner, is in advanced stage. Therefore, even when a user is notified that the consumed level of the consumable item is in advanced stage, there are many cases that the user continues using it for a while, without replacing immediately.

However, if the user continues using the consumable item whose consumed level is in advanced stage, a notice as to advanced consumed level is given so frequently that it may be annoying for the user.

Conventionally, it has been designed such that a setting whether “the notice is given” or “the notice is not given” is possible for each consumable item. Then, as to a consumable item having a setting of “the notice is given”, it is given again and again as far as the consumed level is in advanced stage. On the other hand, as to a consumable item having a setting of “the notice is not given”, any notice is not given regardless of the consumed level.

### SUMMARY OF THE INVENTION

As to the consumable item having a setting of “the notice is given”, it is still notified again and again that the consumed level is in advanced stage, and thus it may be annoying for the user. If the setting of “the notice is not given” is made in order to avoid such annoyance as described above, it is not possible for the user to know the fact that the consumed level is in advanced stage, resulting in inconvenience for the user.

The present invention is directed to enhancing the convenience of a user, regarding a notice that a consumed level of a consumable item in a printer is in advanced stage.

In order to solve the above problems, a print control apparatus provided by the present invention comprises,

an information obtaining means which obtains from a printer, information regarding a consumed level of a consumable item,

a receiving means which selectively receives a setting from a user in which a notice that the consumed level of the consumable item is in advanced stage is limited to once within a predetermined period of time,

a notifying means which notifies the user that the consumed level of the consumable item is in advanced stage, and

a determining means which determines whether or not the user is notified of an advanced consumed level as to the consumable item whose consumed level is found to be in advanced stage, wherein,

when the consumable item whose consumed level is found to be in advanced stage has a setting that the notice as to advanced consumed level is limited to once within the predetermined period of time, and the notice has already been given within the predetermined period of time, the determining means determines that the user is not notified of the advanced consumed level, and when the notice has not been given to the user within the predetermined period of time, the determining means determines that the user is notified of the advanced consumed level.

With a function to receive a setting that the notice as to advanced consumed level is limited to once within a predetermined period of time, it is possible to securely receive the notice at least once within the predetermined period as to the consumable item in the advanced consumed level, as well as avoiding a receipt of the notice repeatedly. Therefore, it is possible to enhance the convenience of the user as to the notice that the consumed level of a consumable item in a printer is in advanced stage.

Here, the predetermined period of time is assumed to be one day, and the determining means is capable of storing a date when the notice is given to the user, if the setting is such that the notice as to advanced consumed level of the consumable item whose consumed level is found to be in advanced stage, is limited to once within the predetermined period of time.

By referring to the information thus stored, it is possible to determine whether or not the notice is to be given.

Further, the receiving means can further selectively receive a setting that the notice as to advanced consumed level is not given, and a setting that the notice as to advanced consumed level is given without limiting the number of times. If the printer is provided with plural types of consumable items, the information obtaining means obtains from the printer, information regarding the consumed level per consumable item, and the receiving means can selectively receive, per consumable item, a setting that the notice as to advanced consumed level of the consumable item is limited to once within a predetermined period of time.

With the above function, options for the user is broadened, a desired setting per consumable item is made possible.

### BRIEF DESCRIPTION OF DRAWINGS

FIG. 1 is a block diagram schematically showing a hardware configuration of a print system 1.

FIG. 2 is a block diagram showing a characteristic functional configuration implemented on the print system 1.

FIG. 3 is a diagram showing an example of a screen for setting a warning notice as to a consumable item.

FIG. 4 is a diagram indicating information which is stored in a printer information storing section 321.

FIG. 5 is a flow diagram describing processes of a printer monitor section 320.

FIG. 6 is a diagram showing an example of a warning notice screen.

### DETAILED DESCRIPTION OF THE PREFERRED EMBODIMENTS

Preferred embodiments of the present invention will be explained with reference to the attached drawings.

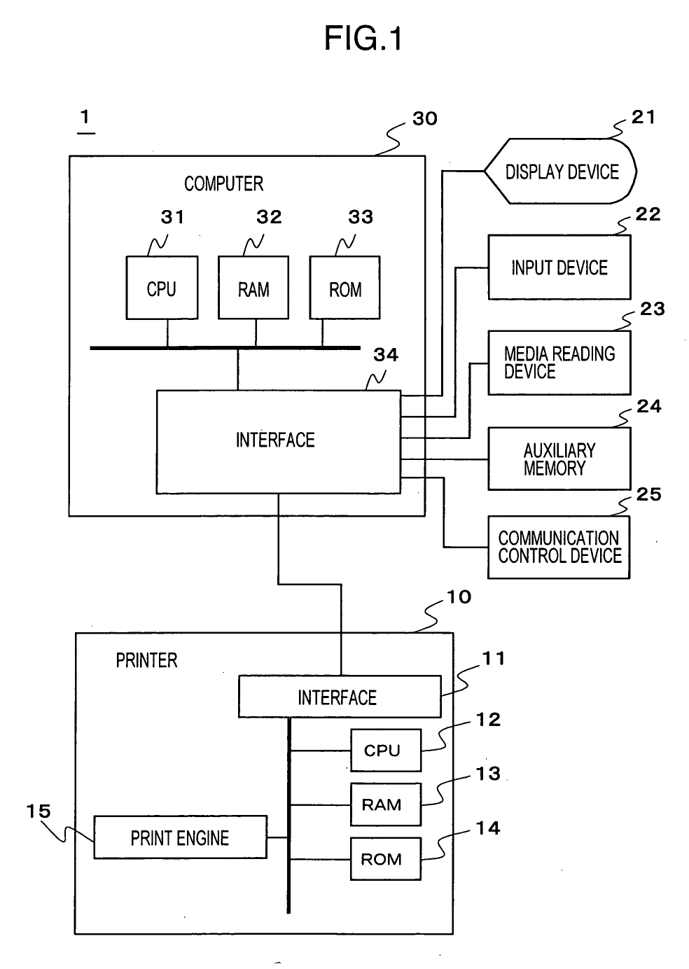

FIG. 1 is a block diagram schematically showing a hardware configuration of a print system 1, which comprises a computer 30 and a printer 10.

The computer 30 comprises a CPU (Central Processing Unit) 31 which performs processing based on various programs, RAM (Random Access Memory) 32 which temporarily stores data, programs and the like, ROM (Read Only Memory) 33 which previously stores various data for controlling the computer 30, a start-up program and the like in nonvolatile manner, and an interface 34 which is responsible for sending/receiving data to/from connected peripheral devices, such as the printer 10. In the present embodiment, computer 30 functions as a print control apparatus.

The computer 30 is connected with a display device 21 such as a color display, an input device 22 such as a mouse and a keyboard, a media reading device 23 which reads data from a recording medium such as a CD-ROM, an internal or external auxiliary memory 24 and a communication control device 25 to establish a connection with the computer network. However, the configuration of the computer 30 is not limited to the one as described above.

The printer 10 is, for example, a laser printer. In the laser printer, a print image based on print data transmitted from the computer 30 is formed on the photoconductor drum by use of laser beam. Then, printing is carried out by allowing toner to adhere on the print image that is electrically charged by the laser beam, and transferring the toner to a print sheet. However, printing is not limited to above manner. For example, it may be a serial printer of ink jet method, and a printer of other printing method.

A toner cartridge filled with toner, a photoconductor drum, a waste toner box for storing excessive toner, those items being provided in the printer 10 and so called consumable items, and they are consumed, deteriorated and the like as printing proceeds. Therefore, the consumable items need replacing when the consumed level thereof is in advanced stage.

The printer 10 comprises an interface 11 which is responsible for a communication with the computer 30, such as data receiving, a CPU 12 which performs a processing based on various programs, RAM 13 which temporarily stores print data and the like, ROM 14 which previously stores various data and various programs and the like for controlling the printer 10 in nonvolatile manner, and a print engine 15 which includes a toner cartridge, a photoconductor drum, laser beam irradiating mechanism, and paper feeding/ejecting mechanism and the like.

The printer 10 further includes in the print engine 15 a mechanism to measure a degree of consumption as to the toner cartridge, the photoconductor drum and the like, the mechanism being a remaining amount sensor and a print number counter, for example. It is to be noted the configuration of the printer 10 is not limited to the one as described above.

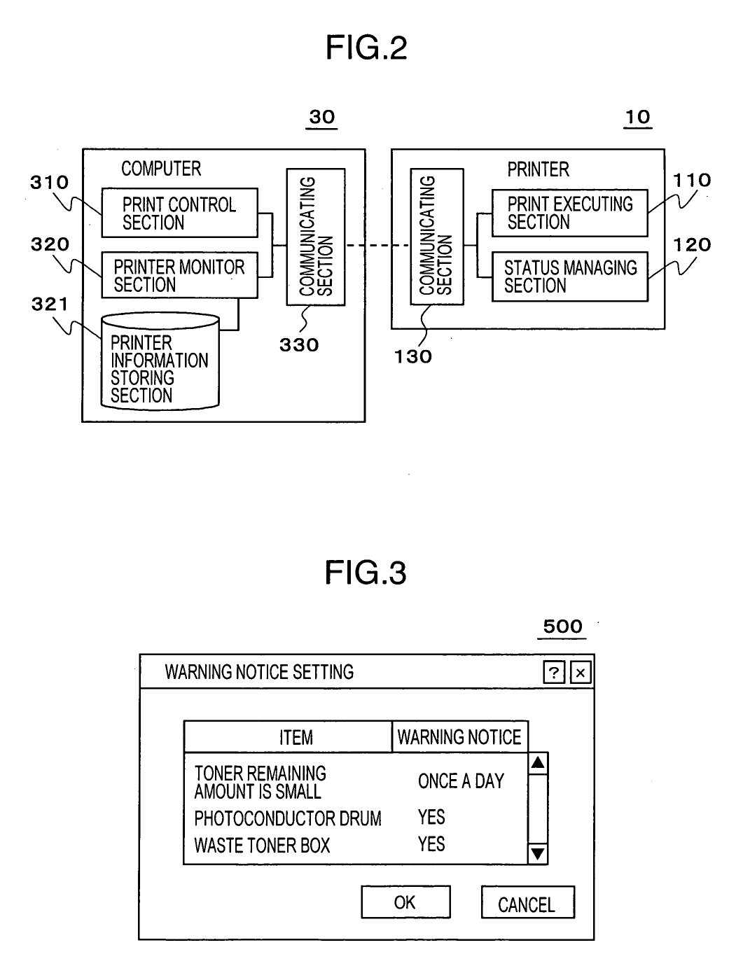

FIG. 2 is a block diagram showing a characteristic functional configuration implemented on the print system 1. In FIG. 2, the computer 30 comprises a print control section 310 which controls a print processing in the print system 1, a printer monitor section 320 which monitors a status of the printer 10 and a communicating section 330 which establishes a communication with the printer 10. The printer monitor section 320 is configured such that it is possible to refer to a printer information storing section 321 which stores information regarding the printer 10.

The print control section 310 serves as a printer host to perform processes such as a process of receiving a print setting from a user, and a process of generating the print data, so that the printer 10 can actually perform printing. The print control section 310 is implemented on the computer 30, for example, when the CPU 31 executes a printer driver program.

The printer monitor section 320 obtains from the printer 10, status information of the printer 10 every predetermined period of time according to an instruction and the like from the user. The status information of the printer 10 includes warning information regarding a consumable item of the printer 10, in addition to the information such as whether or not the printer 10 is in on-line status, and whether or not a cover of the printer 10 is closed.

The warning information regarding the consumable items may be represented, for example, by a string of bits where “1” indicates a status where replacement is recommended and “0” indicates otherwise. Here, it is assumed that the status where replacement is recommended is a status where printing is still possible even if the replacement is not carried out immediately, but if it is left unattended, printing may be disabled, or a printing quality may be gradually degraded.

For example, when it is assumed that the printer 10 employs as its consumable items, consumable item A, consumable item B, consumable item C, and consumable item D, and when the warning information regarding the consumable item indicates “0100”, it means that the consumable item B is in a status where replacement is recommended.

A priority is established in the warnings, and the warning regarding the replacement of consumable items, indicating that printing is still possible even left unattended, has a lower priority than a warning indicating that a cover of the printer 10 is open, out of print paper and the like, where printing is impossible. If a situation occurs where a plurality of warnings should be given simultaneously, it is designed such that a user is notified of a warning having a higher priority.

The printer monitor section 320 determines whether or not a warning is necessary for the user, based on the contents of the warning information regarding the consumable items and a warning notice setting received from the user, which will be described below. When it is determined that the warning is necessary, a warning screen is displayed for the user, advising to replace the consumable item that is in a status where replacement is recommended.

FIG. 3 is a diagram showing an example of a screen for setting the warning notice regarding a consumable item. The printer monitor section 320 receives from the user a warning notice setting command regarding a consumable item, and this screen is displayed on the display device 21.

As shown in FIG. 3, the warning notice setting screen 500 includes a field for displaying each consumable item, and a field for setting a warning notice for each item. Here, in the present embodiment, the warning notice includes three types, i.e., “YES”, “NO” and “ONCE A DAY”, and the user can set any one of the settings for each consumable item.

The setting of “YES” for the warning notice indicates that the warning notice screen is displayed any number of times a day, as far as the pertinent consumable item is in a status that replacement is recommended. It is to be noted that when a consumable item having the setting of “YES” as to the warning notice comes into the status that replacement is recommended, and once a warning notice is displayed, it will not be displayed again as far as the status of the printer 10 is unchanged. This is because, it is necessary to avoid displaying the warning notice every time when the status of the printer 10 is obtained. Alternatively, a warning having a higher priority, such as warning that the cover is opened, is displayed for the user to handle the problem, and after it is settled, the warning regarding the replacement of consumable item is set to be displayed.

The setting of “NO” as to the warning notice indicates that even if the pertinent consumable item in a status that replacement is recommended, a warning notice screen is not displayed.

The setting of “ONCE A DAY” as to the warning notice indicates that if the pertinent consumable item in a status where replacement is recommended, a warning notice screen is displayed only once a day in principle.

It may be possible to modify the “A DAY” of “ONCE A DAY” to another period. For example, it may be “SIX HOURS”, “TWO DAYS”, and the like. Alternatively, an arbitrary period may be set by the user.

The printer monitor section 320 stores the contents of the warning notice setting received from the user in the printer information storing section 321.

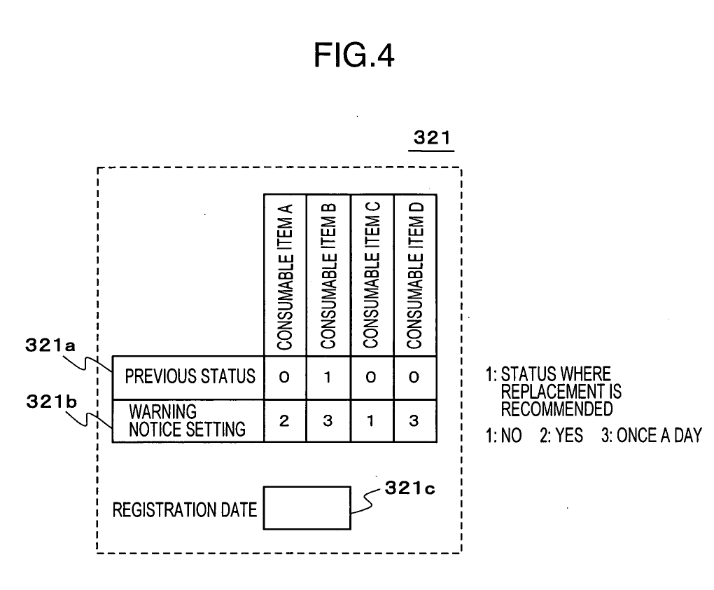

FIG. 4 is diagram showing information which is stored by the printer information storing section 321. As shown in FIG. 4, the printer information storing section 321 stores a previous status 321a and a warning notice setting 321b for each consumable item, and further, a registration date 321c is stored independently.

The previous status 321a stores warning information regarding the consumable items of the printer 10, which has been obtained last time. For example, “1” in the previous status 321a indicates that the pertinent consumable item is in a status that replacement is recommended, and “0” indicates it is not in that status.

The warning notice setting 321b stores a warning notice setting by consumable item, which is set by the user in the warning notice screen 500. In the warning notice setting 321b, for example, “1” represents “NO”, “2” represents “YES”, and “3” represents “ONCE A DAY” as to giving a warning notice.

The registration date 321c stores the latest date when the warning notice was given, as to a consumable item having a warning notice setting of “ONCE A DAY”.

The printer monitor section 320 is implemented on the computer 30, for example, when the CPU 31 executes a printer monitor program. The printer monitor program can be distributed in the market by recoded on a recording medium such as CD-ROM. Further, it can also be distributed in the market via a computer network such as the Internet.

In FIG. 2, the printer 10 comprises a print executing section 110 which executes printing based on print data, a status managing section 120 which manages the status of the printer 10, and a communicating section 130 which establishes a communication with the computer 30.

The status managing section 120 determines according to a predetermined standard, whether or not each consumable item is in a status that replacement is recommended, based on the remaining amount sensor, the print number counter and the like, which are provided in the printer 10. Then, the result is included in the status information as a warning information as to the consumable item. The status managing section 120 also includes in the status information, a warning that a cover of the printer 10 is opened, a warning that the printer 10 is in a warming-up status, and the like, in addition to the warning information regarding the consumable item.

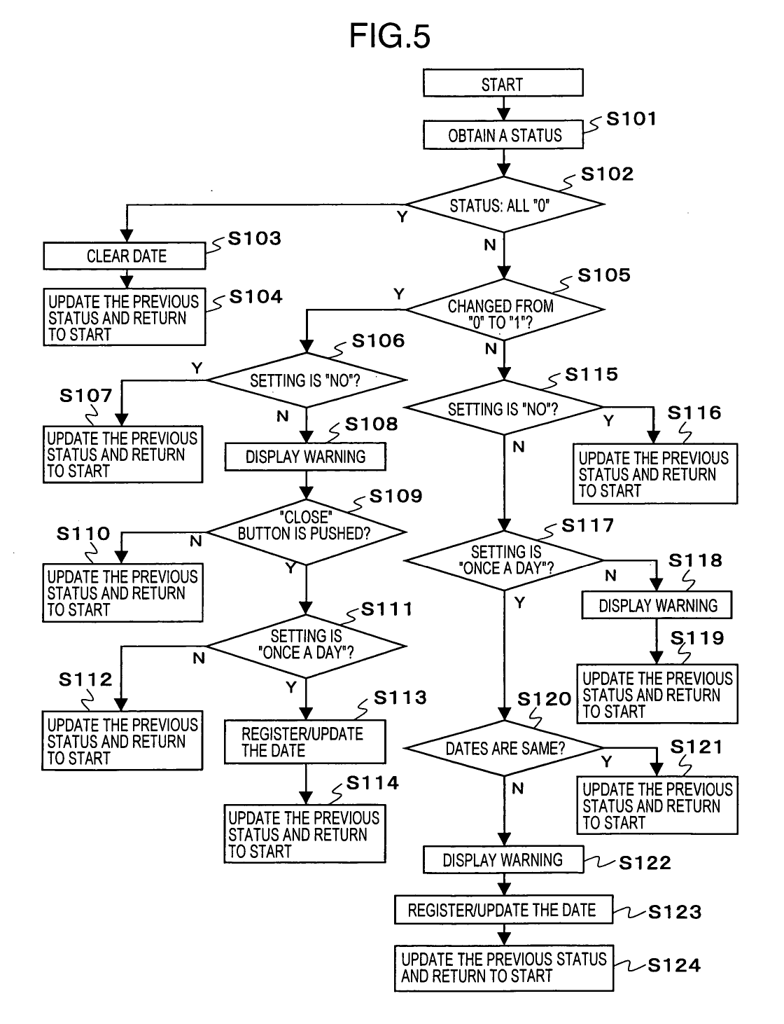

Next, processing of the printer monitor section 320 of the present invention will be explained, with reference to the flow diagram as shown in FIG. 5.

When the print system 1 starts a printing process, the printer monitor section 320 obtains a status of the printer from the status managing section 120 of the printer 10, for example, every 10 seconds (S101).

In the status thus obtained, if the warning information regarding consumable items indicates “0” for all the consumable items (S102: YES), it is not necessary to give a warning notice. Therefore, the registration date 321c in the printer information storing section 321 is cleared, if any date is registered (S103), and the previous status 321a of the printer information storing section 321 is updated with the obtained status. Then, the next status is obtained (S104).

In the status thus obtained, if the warning information regarding the consumable items includes a consumable item having “1” (S102: NO), the previous status 321a of the printer information storing section 321 is referred to, and it is determined whether or not the warning information regarding the pertinent consumable item is changed to “1” from “0”, i.e., this is the first time when the warning information becomes “1” (S105).

As a result, if it is changed from “0” to “1” (S105: YES), it is determined whether or not the warning notice setting 321b regarding the pertinent consumable item, which is recorded in the printer information storing section 321, is “1”, that is, “NO” as to giving the warning notice regarding the consumable item (S106).

As a result, if the warning notice setting 321b is set to “NO” (S106: YES), it is not necessary to give the warning notice. Therefore, the previous status 321a of the printer information storing section 321 is updated with the obtained status, and then, the next status is obtained (S107).

On the other hand, if the warning notice setting 321b is not set to “NO” (S106: NO), a warning notice screen is displayed on the display device 21, and replacement of the consumable item is recommended for the user (S108).

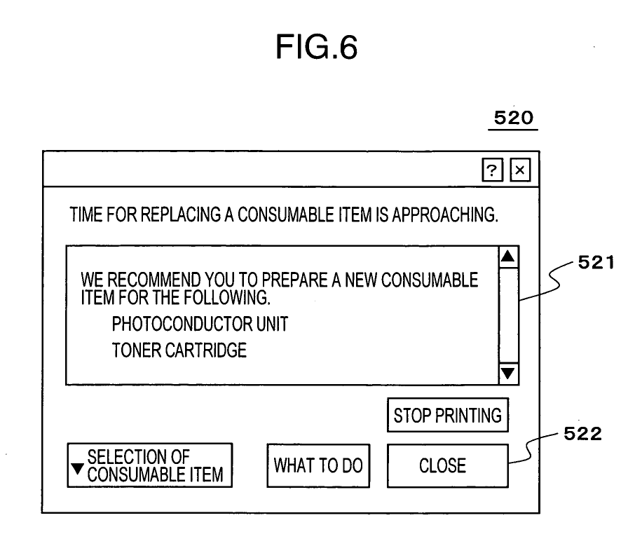

FIG. 6 is a diagram showing an example of the warning notice screen. As shown in FIG. 6, the warning notice screen 520 includes a field 521 for displaying the consumable item being in a status where replacement is recommended. The field 521 for displaying the consumable item being in a status where replacement is recommended displays all the consumable items in that state, regardless of the warning notice setting 321b.

The warning notice screen 520 further comprises a button for stopping printing, a button for displaying a replacement method of the consumable item relating to the warning, a “CLOSE” button 522 for closing the screen 520.

When the warning notice screen 520 is displayed, it is determined whether or not the warning notice screen 520 is closed by the “CLOSE” button 522 (S109) This function is given considering a situation where the warning notice screen 520 is automatically closed. It is automatically closed when a warning having a higher priority occurs, such as the cover of the printer 10 is opened, and the warning notice screen 520 to be displayed is switched to another warning notice of higher priority.

If the warning notice screen 520 is not closed by the “CLOSE” button 522 (S109: NO), there is a possibility that the user has missed a warning notice regarding consumable items. Therefore, even if the warning notice setting 321b is “ONCE A DAY”, the registration date 321c is not updated so that the warning notice regarding the consumable item can be displayed again. Then, the previous status 321a of the printer information storing section 321 is updated with the obtained status, and then, the next status is obtained (S110).

On the other hand, when the warning notice screen 520 is closed by using the “CLOSE” button 522 (S109: YES), it is determined whether or not the warning notice setting 321b is “ONCE A DAY” as to the consumable item having the warning information regarding the consumable item being “1” (S111).

As a result, if the warning notice setting 321b of the consumable item having the warning information “1” is not “ONCE A DAY”, that is, “YES” (S111: NO), the registration date 321c is not updated, and the previous status 321a of the printer information storing section 321 is updated with the obtained status, and then, the next status is obtained (S112).

On the other hand, if the warning notice setting 321b of the consumable item whose warning information is “1” is set to “ONCE A DAY” (S111: YES), the date at that timing is registered in the registration date 321c of the printer information storing section 321 (S113), the previous status 321a of the printer information storing section 321 is updated with the obtained status, and then, the next status is obtained (S114).

If the warning information regarding consumable items includes a consumable item having “1” as a status, and there is not an item whose status has been changed from “0” to “1” (S105: NO), it is determined whether or not the warning notice setting 321b regarding the consumable item having a status of “1” is set to “NO” as to giving the warning notice (S115).

As a result, if the warning notice setting 321b is set to “NO” (S115: Y), it is not necessary to give a warning notice, and thus, the previous status 321a of the printer information storing section 321 is updated with the obtained status, and then, the next status is obtained (S116).

On the other hand, if the warning notice setting 321b is not set to “NO” (S115: NO), it is determined whether or not the warning notice setting 321b is “ONCE A DAY” (S117).

As a result, if the warning notice setting 321b is not “ONCE A DAY”, that is, “YES” as to giving the warning notice (S117: NO), the warning notice screen 520 is displayed on the displaying device 21, and replacement of the consumable item is recommended for the user (S118). However, as described above, once a warning notice is displayed, it will not be displayed again as far as the status of the printer 10 is unchanged. This is because, it is necessary to avoid displaying the warning notice screen 520 every time when the status of the printer 10 is obtained. Alternatively, a warning having a higher priority, such as warning that the cover is opened, is displayed for the user to handle the problem, and after it is settled, the warning regarding the replacement of consumable item may be displayed. Then, the previous status 321a of the printer information storing section 321 is updated with the obtained status, and then, the next status is obtained (S119).

On the other hand, if the warning notice setting 321b is “ONCE A DAY” (S117: YES), it is determined whether or not the date registered in the registration date 321c of the printer information storing section 321 is identical to the date at that timing (S120).

As a result, if the dates are identical to each other (S120: YES), a warning notice has already been given with regard to the consumable item on the same date, a same warning notice screen 520 is not displayed again, and the previous status 321a of the printer information storing section 321 is updated with the obtained status, and then, the next status is obtained (S121)

On the other hand, if the dates are not identical (S120: NO), the warning notice screen 520 is displayed on the display device 21, and replacement of the consumable item is recommended for the user (S122). Then, the date at the timing is registered in the registration date 321c of the printer information storing section 321, or the registration date 321c is updated with the date at the timing (S123), the previous status 321a of the printer information storing section 321 is updated with the obtained status, and then, the next status is obtained (S124).

In the processes where the previous status 321a of the printer information storing section 321 is updated with the obtained status (S107, S112, S116) the registration date 321c of the printer information storing section 321 may be cleared, if the warning notice setting stored in the printer information storing section 321 is “YES” or “NO” for all the consumable items, and there is not a setting of “ONCE A DAY”.

With the processes as described above, according to the present invention, it is possible to enhance the convenience of the user as to a notice that a consumed level of a consumable item in a printer is in advanced stage.

What is claimed is:

1. A print control apparatus comprises,
an information obtaining means which obtains from a printer, information regarding a consumed level of a consumable item,
a receiving means which selectively receives a setting from a user in which a notice that the consumed level of the consumable item is in advanced stage is limited to once within a predetermined period of time,
a notifying means which notifies the user that the consumed level of the consumable item is in advanced stage, and
a determining means which determines whether or not the user is notified of an advanced consumed level as to the consumable item whose consumed level is found to be in advanced stage according to said information regarding the consumed level, wherein,
when the consumable item whose consumed level is found to be in advanced stage has a setting that the notice as to advanced consumed level is limited to once within the predetermined period of time, and said notice has already been given within said predetermined period of time, said determining means determines that the user is not notified of the advanced consumed level, and when said notice has not been given to the user within said predetermined period of time, said determining means determines that the user is notified of the advanced consumed level.

2. A printer control unit according to claim 1, wherein,
said predetermined period of time is one day, and
said determining means stores a date when the notice is given to the user, if the setting is such that the notice as to advanced consumed level regarding the consumable item whose consumed level is in advanced stage, is limited to once within said predetermined period of time.

3. A printer control unit according to claim 1, wherein,
said receiving means further selectively receives a setting that the notice as to the advanced consumed level is not given and a setting that the notice as to advanced consumed level is given without limiting the number of times.

4. A printer control unit according to claim 1, wherein,
said printer is provided with plural types of consumable items,
said information obtaining means obtains information regarding a consumed level per consumable item from said printer, and
said receiving means selectively receives per consumable item a setting that the notice as to advanced consumed level of the consumable item is limited to once within the predetermined period of time.

5. A recording medium on which a computer program is recorded, wherein,
said computer program allows a computer to execute,
an information obtaining process which obtains from a printer, information regarding a consumed level of a consumable item,
a receiving process which selectively receives from a user a setting that a notice as to advanced consumed level of the consumable item is limited to once within a predetermined period of time, and
a process which does not notify the user of the advanced consumed level, if the user is already notified of the advanced consumed level of the consumable item within said predetermined period of time, and which notifies the user of the advanced consumed level, if the user is not notified of the advanced consumed level of the consumable item within said predetermined period of time, when the consumable item, whose consumed level is found to be in advanced stage according to said information regarding said consumed level, has a setting that the notice as to advanced consumed level is limited to once within said predetermined period of time.

6. A recording medium according to claim 5, wherein,
said predetermined period of time is one day, and
said program further allows said computer to execute a process which stores a date when the notice is given to the user, if the setting is such that the notice as to advanced consumed level of the consumable item whose consumed level is in advanced stage, is limited to once within said predetermined period of time.

7. A recording medium according to claim 5, wherein,
said printer is provided with plural types of consumable items,
said information obtaining means obtains information regarding the consumed level per consumable item from said printer, and
said receiving means selectively receives per consumable item a setting that the notice as to advanced consumed level of the consumable item is limited to once within the predetermined period of time.
